(19) United States
(12) Patent Application Publication
(10) Pub. No.: US 2026/0104528 A1
(43) Pub. Date: Apr. 16, 2026

(54) PHOTOSENSITIVE RECOGNITION STRUCTURE FOR MASSAGE HEAD

(71) Applicant: Zhejiang Red And Black Technology Co., Ltd, Zhejiang (CN)

(72) Inventors: Xinyi Shu, Zhejiang (CN); Lifeng Shu, Zhejiang (CN)

(21) Appl. No.: 18/959,443

(22) Filed: Nov. 25, 2024

(30) Foreign Application Priority Data
Oct. 11, 2024 (CN) 2024224507479

(51) Int. Cl. G01V 8/12; A61H 23/00

(52) U.S. Cl. CPC G01V 8/12; A61H 23/006; A61H 2201/0173; A61H 2201/1664; A61H 2201/1685; A61H 2201/5092

(57) ABSTRACT

A photosensitive recognition structure for a massage head includes a massage head, a sliding rod holder, a fixing support, and a light-shading pad. The massage head is detachably connected to the sliding rod holder, the fixing support is disposed inside the sliding rod holder, a mounting groove is provided on the fixing support, a photosensitive sensor and a light source element are disposed inside the mounting groove, and the light-shading pad is disposed at an end of the massage head. When the massage head is connected to the sliding rod holder, the light-shading pad covers the fixing support. When the massage head is connected to the sliding rod holder, the light-shading pad covers the photosensitive sensor. In this case, it is recognized that the massage head is in a connection state.

### TECHNICAL FIELD

The present disclosure relates to a massage device, and in particular to a photosensitive recognition structure for a massage head.

### BACKGROUND

A mounting state and a pull-out state of a massage head can be recognized by a photosensitive sensor disposed in a massage device, which is an important part of ensuring the safe operation of the massage device, implementing intelligent control, and protecting the safety of users.

The existing massage device includes the photosensitive sensor. In a dark or completely dark environment, because the photosensitive sensor is unable to receive light, the photosensitive sensor cannot effectively determine the mounting state of the massage head, thereby affecting the normal use of the massage device or causing potential safety hazards.

### SUMMARY

In view of this, it is necessary to provide a photosensitive recognition structure for a massage head to resolve at least one of the above problems. The photosensitive recognition structure for a massage head includes a massage head, a sliding rod holder, a fixing support, and a light-shading pad, where the massage head is detachably connected to the sliding rod holder, the fixing support is disposed inside the sliding rod holder, a mounting groove is provided on one side of the fixing support, a photosensitive sensor and a light source element are disposed inside the mounting groove, the light-shading pad is disposed at an end of the massage head, and when the massage head is connected to the sliding rod holder, the light-shading pad covers the fixing support. [0005] Preferably, two positioning posts that are disposed symmetrically are disposed on the other side of the fixing support, and a positioning hole matching a shape of the positioning post is provided on the sliding rod holder.

Preferably, the light-shading pad is made of silicone.

Preferably, the positioning post is a hollow post.

Preferably, a sealing ring is sleeved on a rod body, connected to the sliding rod holder, of the massage head.

Preferably, the rod body of the massage head further includes an abutting member, and when the massage head is connected to the sliding rod holder, an end surface of an edge of the sliding rod holder abuts against an end surface of the abutting member.

### BRIEF DESCRIPTION OF THE DRAWINGS

FIG. 1 is a schematic diagram of a structure of a photosensitive recognition structure for a massage head according to an embodiment of the present disclosure;

FIG. 2 is a profile of a photosensitive recognition structure for a massage head according to an embodiment of the present disclosure;

FIG. 3 is an exploded view of a photosensitive recognition structure for a massage head according to an embodiment of the present disclosure;

FIG. 4 is a schematic diagram of a structure that a light-shading pad on the massage head covers a fixing support according to an embodiment of the present disclosure;

FIG. 5 is a schematic diagram of a structure of a sliding rod holder according to an embodiment of the present disclosure; and

FIG. 6 is a schematic diagram of a structure of a fixing support according to an embodiment of the present disclosure.

Reference numerals: 1: massage head; 11: sealing ring; 12: abutting member; 2: sliding rod holder; 21: positioning hole; 3: fixing support; 31: mounting groove; 32: photosensitive sensor; 33: light source element; 34: positioning post; 4: light-shading pad.

### DETAILED DESCRIPTION OF THE EMBODIMENTS

To make the objectives, technical solutions and the advantages of the present disclosure clearer, a photosensitive recognition structure for a massage head provided in the present disclosure is described in further detail below with reference to the drawings and embodiments. Understandably, the described embodiments are merely intended to explain the present disclosure, rather than to limit the present disclosure.

It should be understood that in the description of the present disclosure, unless otherwise specified, “a plurality of” means two or more; and terms such as “central”, “longitudinal”, “transverse”, “upper”, “lower”, “left”, “right”, “inside”, “outside”, “front”, “rear”, “head”, “tail”, “vertical”, “horizontal”, “top”, and “bottom” indicate the orientation or position relationships based on the drawings. They are merely intended to facilitate and simplify the description of the present disclosure, rather than to indicate or imply that the mentioned device or components must have a specific orientation or must be constructed and operated in a specific orientation. Therefore, these terms should not be construed as a limitation to the present disclosure. Moreover, the terms “first”, “second”, and “third” are merely used for description, and are not intended to indicate or imply relative importance.

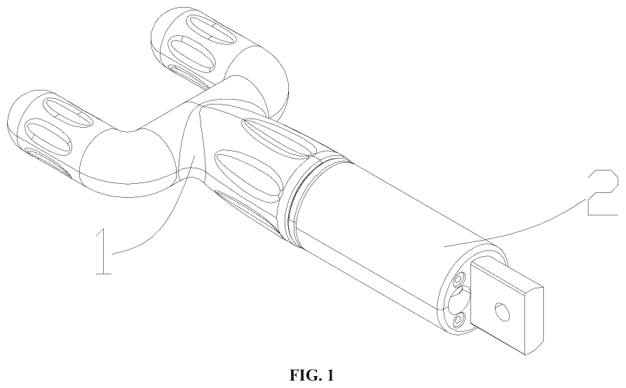

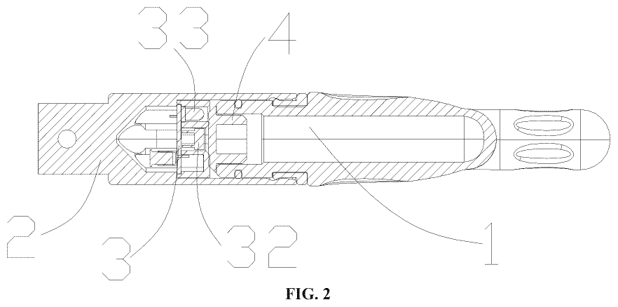

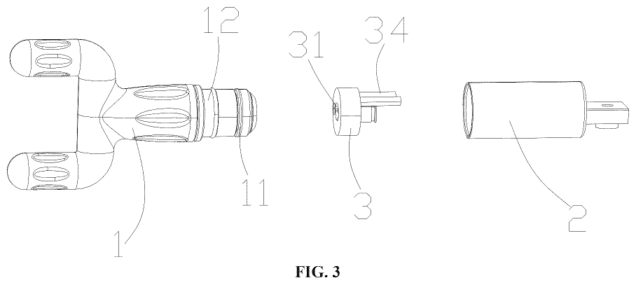

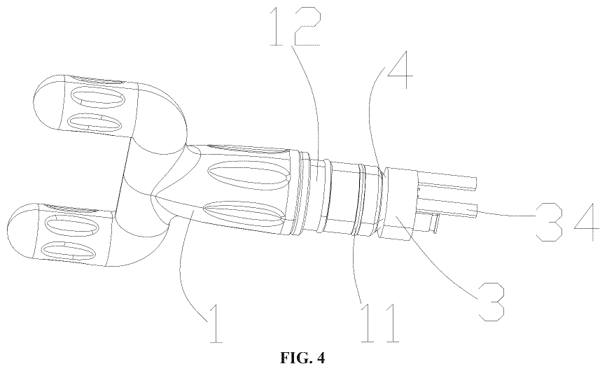

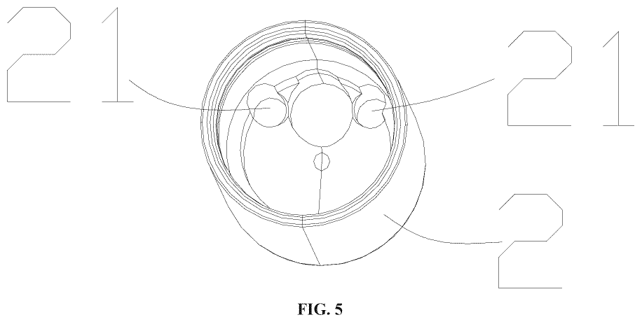

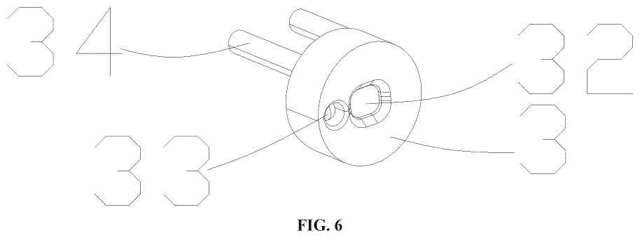

In the description of the present disclosure, it should be noted that, unless otherwise clearly specified, meanings of terms “install”, “connected with”, and “connected to” should be understood in a board sense. For example, the connection may be a fixed connection, a removable connection, or an integral connection; may be a mechanical connection or an electrical connection; may be a direct connection or an indirect connection by using an intermediate medium; or may be intercommunication between two components. Those of ordinary skill in the art may understand specific meanings of the above terms in the present disclosure based on a specific situation. [0020] Referring to FIG. 1 to FIG. 6, a photosensitive recognition structure for a massage head provided in the embodiments of the present disclosure includes a massage head 1, a sliding rod holder 2, a fixing support 3, and a light-shading pad 4. The massage head 1 is detachably connected to the sliding rod holder 2, the fixing support 3 is disposed inside the sliding rod holder 2, a mounting groove 31 is provided on one side of the fixing support 3, a photosensitive sensor 32 and a light source element 33 are disposed inside the mounting groove 31, and the light-shading pad 4 is disposed at an end of the massage head 1. When the massage head 1 is connected to the sliding rod holder 2, the light-shading pad covers the fixing support 3.

In this embodiment, the photosensitive recognition structure for a massage head 1 ensures that a connection state of the massage head 1 can be accurately recognized under different light conditions, especially in a dark environment.

The massage head 1 is detachably connected to the sliding rod holder 2, for example, connected in a threaded connection, which is not limited herein. The massage head 1 is coaxially disposed with the sliding rod holder 2, the fixing support 3 is firmly mounted inside the sliding rod holder 2, the mounting groove 31 is provided on one side of the fixing support 3, and the photosensitive sensor 32 and the light source element 33 are disposed inside the mounting groove 31. The photosensitive sensor 32 is responsible for detecting changes in light. As an auxiliary light source, the light source element 33 emits light when needed. A printed circuit board (PCB) is further disposed in the fixing support, and the PCB is electrically connected to the photosensitive sensor 32 and the light source element 33.

The light-shading pad 4 is mounted at the end of the massage head 1. When the massage head 1 is connected to the sliding rod holder 2, the light-shading pad 4 automatically covers the fixing support 3 and the mounting groove 31, and in particular covers the photosensitive sensor 32, thereby blocking the interference of external light with the photosensitive sensor. In this state, the photosensitive sensor 32 may not receive the light from the light source element 33 and recognize that the massage head 1 has been connected.

On the contrary, in the dark environment, if the massage head 1 is pulled out of the sliding rod holder 2, the light-shading pad 4 leaves the fixing support 3 and does not cover the mounting groove 31. In this case, the light source element 33 is activated, and the light emitted from the light source element 33 directly shines on the photosensitive sensor 32. After receiving the light signal, the photosensitive sensor recognizes that the massage head 1 is in a pull-out state.

Due to this mechanism, the photosensitive recognition structure for a massage head can work normally under conventional light, and can maintain a recognition capability with high accuracy in the dark environment. This ensures that the intelligent control of the massage device is not limited by light conditions, and improves user experience.

Referring to FIG. 1 to FIG. 6, in another embodiment, two positioning posts 34 that are disposed symmetrically are disposed on the other side of the fixing support 3, and a positioning hole 21 matching a shape of the positioning post 34 is provided on the sliding rod holder 2.

In this embodiment, the positioning hole 21 matching the shape of the positioning post 34 is provided at a corresponding position on the sliding rod holder 2, ensuring that the sliding rod holder 2 can be seamlessly connected to the positioning post 34. The main principle of this design is that the fixing support 3 can be firmly disposed inside the sliding rod holder 2 by accurately matching the positioning post 34 with the positioning hole 21, to implement accurate positioning. This limiting mechanism effectively prevents the fixing support 3 from shaking or offsetting inside the sliding rod holder 2, and maintains stability of the fixing support 3 in a dynamic use environment. Therefore, regardless of changes in an external environment, the light-shading pad 4 can accurately cover the fixing support 3 and the photosensitive sensor 32 on the fixing support 3. This ensures that the photosensitive recognition function can be normally enabled and is not affected by the position offset of the fixing support 3.

Referring to FIG. 1 to FIG. 6, in another embodiment, the light-shading pad 4 is made of silicone.

In this embodiment, the silicone is selected based on excellent physical properties and adaptability of the silicone. The silicone has good softness and elasticity, and can closely fit a surface of the fixing support 3, to effectively block light, thereby ensuring that the photosensitive sensor 32 is not interfered with external light when needed. In addition, abrasion and aging resistance of the silicone ensures long-term stability and reliability of the light-shading pad 4, extending the service life of the photosensitive recognition structure for a massage head. Furthermore, the silicone has a specific degree of self-lubrication, which enables the massage head 1 to be used smoothly during mounting and removal processes. Therefore, user experience is improved.

Referring to FIG. 1 to FIG. 6, in another embodiment, the positioning post 34 is a hollow post.

In this embodiment, the positioning post 34 is designed as a hollow post. This structural principle is to optimize the use of materials and the implementation of functions. Compared with a solid post, the hollow post can reduce the overall weight while ensuring sufficient strength, so that a weight of a combination of the fixing support 3 and the sliding rod holder 2 is lighter.

Referring to FIG. 1 to FIG. 6, in another embodiment, a sealing ring 11 is sleeved on a rod body, connected to the sliding rod holder 2, of the massage head 1.

In this embodiment, in a connection structure of the massage head 1 and the sliding rod holder 2, the sealing ring 11 is sleeved on the rod body. This design is intended to enhance the sealing of a connection part, and prevent dust, moisture or other impurities from entering the internal mechanism, thereby preventing precision components such as the photosensitive sensor 32 from being damaged. The sealing ring 11 is made of an elastic material, for example, rubber or silicone, and may be closely attached to contact surfaces between the rod body and the sliding rod holder 2, to form an effective sealing barrier.

Referring to FIG. 1 to FIG. 6, in another embodiment, the rod body of the massage head 1 further includes an abutting member 12, and when the massage head 1 is connected to the sliding rod holder 2, an end surface of an edge of the sliding rod holder 2 abuts against an end surface of the abutting member 12.

In this embodiment, when the massage head 1 is mounted to the sliding rod holder 2, the end surface of the edge of the sliding rod holder 2 is directly in contact with the end surface of the abutting member 12, to generate an abutting force. This abutting mechanism ensures solidity of the massage head 1 at the connection position, which prevents the massage head 1 from loosening or falling off due to an external force or vibration. In addition, the abutting member 12 further implements limiting and cushioning functions, and avoids abrasion caused by direct contact between the rod body of the massage head 1 and the sliding rod holder 2. This enhances durability and stability of the photosensitive recognition structure for a massage head.

The above embodiments are only preferred ones of the present disclosure, and are not intended to limit the present disclosure in any form. Although the present disclosure has been disclosed by the foregoing embodiments, these embodiments are not intended to limit the present disclosure. Any person skilled in the art may make some changes or modifications to implement equivalent embodiments with equivalent changes by using the technical contents disclosed above without departing from the scope of the technical solution of the present disclosure. Any simple modification, equivalent change and modification made to the foregoing embodiments according to the technical essence of the present disclosure without departing from the content of the technical solution of the present disclosure shall fall within the scope of the technical solution of the present disclosure.

What is claimed is:

1. A photosensitive recognition structure for a massage head, comprising a massage head, a sliding rod holder, a fixing support, and a light-shading pad, wherein the massage head is detachably connected to the sliding rod holder, the fixing support is disposed inside the sliding rod holder, a mounting groove is provided on one side of the fixing support, a photosensitive sensor and a light source element are disposed inside the mounting groove, the light-shading pad is disposed at an end of the massage head, and when the massage head is connected to the sliding rod holder, the light-shading pad covers the fixing support.

2. The photosensitive recognition structure for a massage head according to claim 1, wherein two positioning posts that are disposed symmetrically are disposed on the other side of the fixing support, and a positioning hole matching a shape of the positioning post is provided on the sliding rod holder.

3. The photosensitive recognition structure for a massage head according to claim 1, wherein the light-shading pad is made of silicone.

4. The photosensitive recognition structure for a massage head according to claim 2, wherein the positioning post is a hollow post.

5. The photosensitive recognition structure for a massage head according to claim 1, wherein a sealing ring is sleeved on a rod body, connected to the sliding rod holder, of the massage head.

6. The photosensitive recognition structure for a massage head according to claim 5, wherein the rod body of the massage head further comprises an abutting member, and when the massage head is connected to the sliding rod holder, an end surface of an edge of the sliding rod holder abuts against an end surface of the abutting member.
